(19) United States
(12) Patent Application Publication
(10) Pub. No.: US 2021/0209321 A1
(43) Pub. Date: Jul. 8, 2021

(54) CONTROL INFORMATION INTERACTION METHOD AND SMART ROBOT

(71) Applicant: YUTOU TECHNOLOGY (HANGZHOU) CO., LTD., Hangzhou City, Zhejiang (CN)

(72) Inventor: Mingxiu CHEN, Hangzhou City, Zhejiang (CN)

(73) Assignee: YUTOU TECHNOLOGY (HANGZHOU) CO., LTD., Hangzhou City, Zhejiang (CN)

(21) Appl. No.: 15/999,649

(22) PCT Filed: Feb. 20, 2017
(86) PCT No.: PCT/CN2017/074051

§ 371 Date: Aug. 20, 2018

(30) Foreign Application Priority Data
Feb. 23, 2016 (CN) 201610099385.0

(51) Int. Cl. G06K 7/14; G06K 19/06; G06K 7/10; G05B 19/4155

(52) U.S. Cl. CPC G06K 7/1417; G06K 19/06037; G05B 2219/50391; G05B 19/4155; G06K 7/10722

(57) ABSTRACT

Disclosed are a control information interaction method and a smart robot, falling within the technical field of smart devices. The method comprises: step S1, a user inputting control information to a user end; step S2, the user end forming alternative information having a preset form according to the control information and outputting same; step S3, the smart robot receiving the alternative information, and performing parsing according to the alternative information to obtain corresponding parsed information; and step S4, the smart robot performing restoration according to the parsed information to obtain the control information, and executing a corresponding operation according to the control information. The beneficial effects of the technical solution are: being capable of making human-machine interaction between a user and a smart robot more convenient and rapid, and ensuring the accuracy of information interaction.

### CROSS-REFERENCE TO RELATED APPLICATIONS

The present application claims priority to and the benefit of Chinese Patent Application No. CN 201610099385.0 filed on Feb. 23, 2016, the entire content of which is incorporated herein by reference.

### BACKGROUND OF THE INVENTION

### 1. Field of the Invention

The present invention relates to the technical field of intelligent equipment, in particular to an intelligent robot and a method for control information interaction.

### 2. Description of the Related Art

With the manufacture of the intelligent device and the rapid development of research and development technology, an intelligent robot, a special intelligent device, begins to enter people's lives. The so-called intelligent robot is an intelligent device with multiple functions, that is, different functions of different types of intelligent devices are integrated in an intelligent device. For example, there may be integrated with audio playing function of audio playing equipment, video playing function of video playing equipment, voice dialogue function of intelligent voice equipment, and other types of functions in one intelligent robot.

In the prior art, the interaction of the control information between an user and the intelligent robot can generally be performed in the following ways: 1) inputting control information directly via an input device (such as a keyboard or a touch screen) provided by the intelligent robot; and 2) interacting with the intelligent robot by the means of speech input; and 3) interacting with the intelligent robot by making specific hand gestures.

There exists common problems in the above three methods that information interaction process is slow and inconvenient, and that the accuracy of speech recognition and gesture recognition is not high in the prior art, and there is a possibility of error recognition. So the accuracy of the control information interaction may be degraded, thereby the user experience may be reduced.

### SUMMARY OF THE INVENTION

According to the problems existing in the prior art, the present invention provides technical solutions of an intelligent robot and a method for control information interaction. The present invention aims at making the human-computer interaction between the user and the intelligent robot more convenient and fast, and ensuring the accuracy of the information interaction.

The above technical solutions specifically comprise: A method for control information interaction, comprising an user terminal and an intelligent robot; further comprising:

Step S1, the user inputs control information into the user terminal;

Step S2, the user terminal forms replacement information with a preset form according to the control information and outputs the replacement information;

Step S3, the intelligent robot receives the replacement information, and a parse is done to obtain a corresponding parsed information according to the replacement information; and

Step S4, the intelligent robot restores it to obtain the control information according to the parsed information, and performs a corresponding operation according to the control information.

Preferably, the method for control information interaction, wherein the preset form is a two-dimensional bar code form; and the replacement information is two-dimensional bar code information in the form of the two-dimensional bar code.

Preferably, the method for control information interaction, wherein the user terminal is an intelligent terminal provided with a display device; and in Step 2, the replacement information is output in such a manner that the replacement information is displayed on the display device.

Preferably, the method for control information interaction, wherein, in Step S3, the intelligent robot receives the replacement information by using an image capturing device.

Preferably, the method for control information interaction, wherein Step S2 comprising:

Step S21, the user terminal encrypts the control information to form a corresponding plaintext information;

Step S22, the user terminal forms the replacement information with the preset form according to the plaintext information; and

Step S23, the user terminal outputs the replacement information; wherein the parsed information is the plaintext information.

Preferably, the method for control information interaction, wherein Step S3 comprising:

Step S31, the intelligent robot uses the image capturing device to acquire image information;

Step S32, the intelligent robot judges whether the replacement information exists in the image information or not;

and if not, returning to Step S31;

Step S33, the intelligent robot receives the replacement information and parses it to obtain the corresponding parsed information, and then turning to Step S4.

An intelligent robot, using the method for control information interaction of claims 1-6.

The technical solution' beneficial effects are as follows: the invention provides a method for control information interaction, which can make the human-computer interaction between the user and the intelligent robot more convenient and fast, and ensure accuracy of information interaction.

### BRIEF DESCRIPTION OF THE DRAWINGS

The accompanying drawings, together with the specification, illustrate exemplary embodiments of the present disclosure, and, together with the description, serve to explain the principles of the present invention.

FIG. 1 is an overall flow diagram of a method for control information interaction in a preferred embodiment of the present invention,

FIGS. 2-3 are step-by-step flow diagrams of a method for control information interaction in a preferred embodiment of the present invention.

### DETAILED DESCRIPTION

The present invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” or “has” and/or “having” when used herein, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, the term “plurality” means a number greater than one.

Hereinafter, certain exemplary embodiments according to the present disclosure will be described with reference to the accompanying drawings.

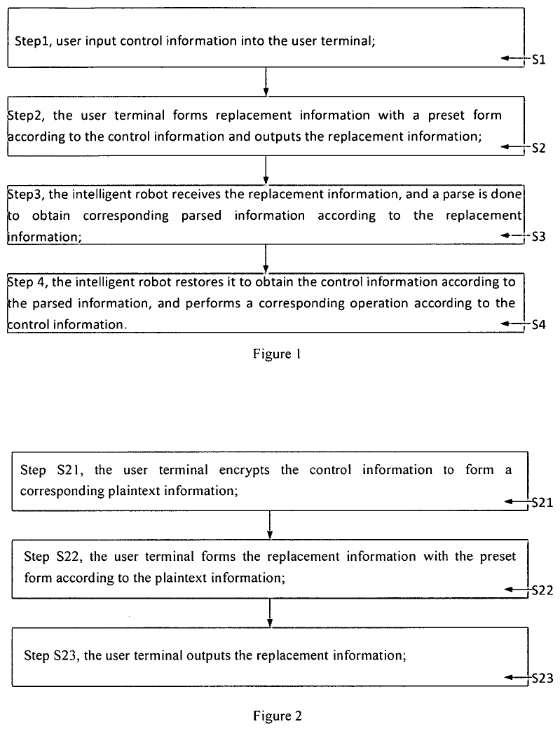

In a preferred embodiment of the present invention, it provides a method for control information interaction based on the above-mentioned problems of the prior art and the method is suitable for intelligent robots. As shown in FIG. 1, the method comprises the steps as follows:

Step S1, the user inputs the control information into the user terminal;

Step S2, the user terminal forms replacement information with the preset form according to the control information and outputs the replacement information;

Step S3, the intelligent robot receives the replacement information, and a parse is done to obtain a corresponding parsed information according to the replacement information; and

Step S4, the intelligent robot restores it to obtain the control information according to the parsed information, and performs a corresponding operation according to the control information.

In a specific embodiment, the user inputs control information into the user terminal first, the control information is an operation which the user desires the intelligent robot to execute. For example, if the user wants the intelligent robot to play a certain piece of music or the like, first, the user inputs specific control information into the user terminal, wherein the specific control information can be used to control the intelligent robot to perform the operation described above.

Subsequently, in this embodiment, the user terminal forms replacement information having a preset form based on the above control information. Specifically, the so-called preset form may be a two-dimensional bar code form, and the above-described replacement information may be two-dimensional bar code information. Therefore, in Step S2, the user terminal actually generates and outputs the corresponding two-dimensional bar code information on the basis of the control information. Two-dimensional bar code is black and white graphics used to record the control information. The black and white graphics is a particular geometric figure which is distributed in a planar two-dimensional direction in accordance with a certain law. The two-dimensional bar code utilizes the concept of “0” and “1” bit streams of the internal logical basis of a computer, and uses a plurality of different geometries corresponding to the binary to represent the above-described control information. The use of two-dimensional bar code as the information presentation form of the replacement information has a function to verify the information and also has a function to automatically identify the information in different lines, as well as a function to process the graphics rotation change point and other functions. Therefore, the use of two-dimensional bar code to present the replacement information can ensure the accuracy of information, and can also present information more conveniently.

In this embodiment, the intelligent robot receives the above-described replacement information (i.e., two-dimensional bar code information) presented in the form of a two-dimensional bar code. Then the replacement information is parsed to obtain a corresponding parsed result, and finally the parsed result is restored to obtain the corresponding control information, and performs a corresponding operation according to the control information. In other words, in this embodiment, the interaction of the control information between the user terminal (the user) and the intelligent robot can be done by using the replacement information in the preset form.

In a preferred embodiment of the present invention, the user terminal may be an intelligent terminal with a display device (display screen), and further may be a mobile terminal with a display device. In Step S2, the replacement information is output in such a manner that the replacement information is displayed on the display device. In other words, the intelligent robot can acquire the replacement information in the form of the two-dimensional bar code by utilizing its own image capturing device (camera), and finally obtains the control information based on the replacement information.

Therefore, in a preferred embodiment of the present invention, in Step S2, the user can display the replacement information in the form of a two-dimensional bar code on the display screen of the intelligent terminal, then in Step S3, the intelligent robot can acquire the replacement information through its own camera. In the prior art, since a two-dimensional bar code scan needs a sufficient light condition, it may not be possible to perform a related scanning operation based on a two-dimensional bar code in the dark, unless an infrared scanning device is added, thus it increases the cost. In the technical solution of the present invention, as the display screen of the intelligent terminal itself can carry the background light when displaying, it is possible to solve the problem of the two-dimensional bar code scanning in the dark environment.

In a preferred embodiment of the present invention, if the technical solution of the present invention is carried out in a place with light, it is also possible to present the replacement information in the type of the two-dimensional bar code by printing the two-dimensional bar code on paper or in other ways, thereby providing the intelligent robot to acquire and receive the replacement information.

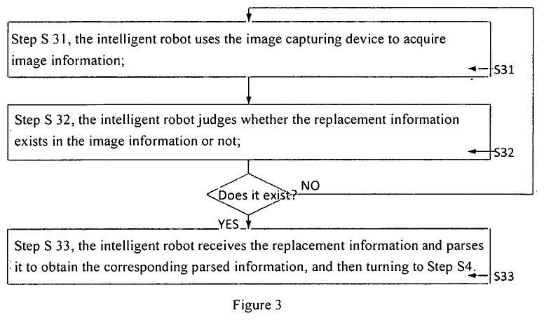

In a preferred embodiment of the present invention, as shown in FIG. 2, the above-mentioned Step S2 specifically comprising:

Step S21, the user terminal encrypts the control information to form a corresponding plaintext information;

Step S22, the user terminal forms the replacement information with the preset form according to the plaintext information; and

Step S23, the user terminal outputs the replacement information;

wherein the parsed information is the plaintext information.

Specifically, in a preferred embodiment of the present invention, after the user inputs the control information into the user terminal, the control information needs to be encrypted before conversion in order to ensure the security of the control information interaction. The encryption can be performed using a preset or randomly generated key, or the control information can be encrypted and converted according to a preset format. After encryption of the control information, the corresponding plaintext information can be generated, and then the user terminal forms the replacement information with the preset form through the plaintext information, that is, the replacement information in the form of the two-dimensional bar code can be generated according to the plaintext information. Finally, the user terminal outputs the replacement information.

In Step S3 and Step S4, the so-called parsed information means plaintext information. In other words, after the intelligent robot receives the replacement information and parses it, it gets the corresponding plaintext information output, but not directly gets the control information, so as to ensure the information security in the process of the control information interaction.

Then, in a preferred embodiment of the present invention, in Step S4, the intelligent robot decrypts the plaintext information according to the encryption mode previously performed by the user terminal, thereby restoring the plaintext information to obtain a corresponding control information. For example, the same key as the user terminal is set in the intelligent robot, and the key is used to decrypt the plaintext information; for example, the plaintext information is decrypted in a decryption format which is corresponding to a encryption format, and the encryption format is used when the user terminal performs encryption.

In a preferred embodiment of the present invention, as shown in FIG. 3, the above Step S3 specifically comprising:

Step S31, the intelligent robot uses the image capturing device to acquire image information;

Step S32, the intelligent robot judges whether the replacement information exists in the image information or not;

and if not, returning to Step S31; Step S33, the intelligent robot receives the replacement information and parses it to obtain the corresponding parsed information, and then turning to Step S4.

Particularly, in a preferred embodiment of the present invention, the image capturing device provided in the intelligent robot has a certain image acquisition area. After the replacement information is formed on the user terminal, the replacement information is displayed on the display screen of the user terminal (or printed directly on the paper) and placed in the image acquisition area for identification performed by the image capturing device. Generally, the replacement information is placed at a position facing towards the image capturing device.

In a preferred embodiment of the present invention, the intelligent robot acquires the image located in the image acquisition area by using the image capturing device and determines whether the replacement information in the form of the two-dimensional bar code exists in the image or not. The acquisition and the determination can be performed by scanning an image in an image acquisition area in a certain order (for example, from top to bottom) and acquiring the two-dimensional bar code information if there is a two-dimensional bar code information found in the image during the scanning; otherwise, returning and resuming the scanning.

In a preferred embodiment of the present invention, when the intelligent robot receives the replacement information, it performs the steps as described above, that is, parses the replacement information to obtain the parsed information (i.e., plaintext information), and then turning to Step S4.

As described above, in the technical solution of the present invention, the user inputs the control information into the user terminal (for example, the intelligent terminal), and the control information is converted into the replacement information having the preset form (for example, a two-dimensional bar code form) and displayed. The intelligent robot uses the image capturing device to receive the replacement information and parses it to obtain the corresponding parsed information (i.e., plaintext information), and then restores the parsed information to obtain the final control information, and executes a corresponding operation according to the control information. The interactive process of the control information can make the human-computer interaction between the user and the intelligent robot more convenient and fast, and ensure the accuracy of information interaction.

In a preferred embodiment of the present invention, it is also provided an intelligent robot, wherein the method for control information interaction as described above is employed.

The subject matter described above is provided by way of illustration only and should not be construed as limiting of the embodiments and scope of the invention. Those skilled in the art should be able to realize that various modifications and changes can be made according to the subject matter described herein without following the example embodiments and applications illustrated and described, and without departing from the true spirit and scope of the present invention, which is set forth in the following claims.

What is claimed is:

1. A method for control information interaction, comprising an user terminal and an intelligent robot; further comprising:
Step S1, the user inputs control information into the user terminal;
Step S2, the user terminal forms replacement information with a preset form according to the control information and outputs the replacement information;
Step S3, the intelligent robot receives the replacement information, and a parse is done to obtain a corresponding parsed information according to the replacement information; and
Step S4, the intelligent robot restores it to obtain the control information according to the parsed information, and performs a corresponding operation according to the control information.

2. The method for control information interaction of claim 1, wherein the preset form is a two-dimensional bar code form; and
the replacement information is two-dimensional bar code information in the form of the two-dimensional bar code.

3. The method for control information interaction of claim 2, wherein the user terminal is an intelligent terminal provided with a display device; and
in Step 2, the replacement information is output in such a manner that the replacement information is displayed on the display device.

4. The method for control information interaction of claim 2, wherein, in Step S3, the intelligent robot receives the replacement information by using an image capturing device.

5. The method for control information interaction of claim 1, wherein Step S2 comprising:
Step S21, the user terminal encrypts the control information to form a corresponding plaintext information;
Step S22, the user terminal forms the replacement information with the preset form according to the plaintext information; and
Step S23, the user terminal outputs the replacement information;
wherein the parsed information is the plaintext information.

6. The method for control information interaction of claim 3, wherein Step S3 comprising:
Step S31, the intelligent robot uses the image capturing device to acquire image information;
Step S32, the intelligent robot judges whether the replacement information exists in the image information or not;
and if not, returning to Step S31;
Step S33, the intelligent robot receives the replacement information and parses it to obtain the corresponding parsed information, and then turning to Step S4.

7. An intelligent robot, using a method for control information interaction, the method comprising an user terminal and an intelligent robot, and further comprising:
Step S1, the user inputs control information into the user terminal;
Step S2, the user terminal forms replacement information with a preset form according to the control information and outputs the replacement information;
Step S3, the intelligent robot receives the replacement information, and a parse is done to obtain a corresponding parsed information according to the replacement information; and
Step S4, the intelligent robot restores it to obtain the control information according to the parsed information, and performs a corresponding operation according to the control information.

8. The intelligent robot of claim 7, wherein the preset form is a two-dimensional bar code form; and
the replacement information is two-dimensional bar code information in the form of the two-dimensional bar code.

9. The intelligent robot of claim 8, wherein the user terminal is an intelligent terminal provided with a display device; and
in Step 2, the replacement information is output in such a manner that the replacement information is displayed on the display device.

10. The intelligent robot of claim 8, wherein, in Step S3, the intelligent robot receives the replacement information by using an image capturing device.

11. The intelligent robot of claim 7, wherein Step S2 comprising:
Step S21, the user terminal encrypts the control information to form a corresponding plaintext information;
Step S22, the user terminal forms the replacement information with the preset form according to the plaintext information; and
Step S23, the user terminal outputs the replacement information;
wherein the parsed information is the plaintext information.

12. The intelligent robot of claim 9, wherein Step S3 comprising:
Step S31, the intelligent robot uses the image capturing device to acquire image information;
Step S32, the intelligent robot judges whether the replacement information exists in the image information or not;
and if not, returning to Step S31;
Step S33, the intelligent robot receives the replacement information and parses it to obtain the corresponding parsed information, and then turning to Step S4.
